(19) United States
(12) Patent Application Publication
(10) Pub. No.: US 2004/0123481 A1
(43) Pub. Date: Jul. 1, 2004

(54) Depth gauge indicator for post-hold digger handle

(76) Inventor: James Perry Stewart, Mansfield, OH (US)

Correspondence Address: James P. Stewart, 57 Yoha Dr., Mansfield, OH, 44907, US

(21) Appl. No.: 10/331,701

(22) Filed: Dec. 30, 2002

(51) Int. Cl. G01B 3/22

(52) U.S. Cl. 33/836

(57) ABSTRACT

An improved Depth Gauge Indicator for providing a ready depth measurement without requiring a standard tape measure. The operator can pre-set the intended depth of a hole before the act of digging begins. The depth gauge indicator provides a visible reference as to the depth of the hole. If several depths of holes are needed the operator is able to adjust the Depth Gauge Indicator without removing it.

### BACKGROUND OF THE INVENTION

This invention relates to the field of tool handles. More particularly, it relates to an Improved tool handle for a post-hole digger incorporating a depth gauge reference Indicator.

In the act of digging a hole manually, a predetermined depth is known before the act of Digging has commenced. A standard tape measure could be used to continue to monitor The depth of the hole which this act by itself is a time consuming process. Another Method that is common practice is to place a mark or notch onto the handle, this saves The time of reaching for a tape measure, but this method could be confusing as to which Mark is the correct one?

U.S. Pat. No. 5,820,183 was issued to Marcus Oct., 13 1998 discloses a tool handle That contains graduations of measurement and a flexible hook and loop attachment System To be utilized as a reference mark. Anyone skilled in utilizing hook and loop type Fasteners realizes they need to be clean and free of debris in order for them to work Properly. Posthole diggers are placed in an environment, which they are continually Subjected to dirt and mud. If several depths of Holes need to be dug the operator needs to Unfasten the hook and loop systems move to The Next reference point and then refasten The hook and loop attachment. If the hook and Loops are filled with dirt or mud they first Need to be clean before being attached. This is A time consuming process. A further disadvantage of using a hook and loop fastener system is they wear Out and not fasten as intended.

### SUMMARY OF THE INVENTION

In accordance with the various features of this invention, an improved depth gauge reference indicator for a post hole digger handle.

An O-Ring is a suitable device to be used as a Depth Gauge Reference Indicator. The shape of the O-Ring allows for movement up or down an elongated handle without detaching the O-Ring from the handle. The O-Ring is attached to the handle by the act of rolling the O-Ring down from the proximal end of the handle. Once attached it never has to be removed from the handle, assuring the operator of never misplacing the O-Ring.

The material O-Rings are made of insures that they will not be damaged in the environment that it will be subject to. The material allows for elasticity to the O-Ring allowing it to stretch and form to various shapes and sizes of post-hole digger handles.

The O-Ring is dimensioned to allow a tight frictional fit to prevent any unnecessary movement, But not so tight as to prevent movement with nominal pressure from a hand. A gauge that is affixed to the handle of the post-hole digger serves as a reference for placement of the O-Ring during the act of digging a hole.

### DESCRIPTION OF DRAWINGS

FIG. 1 Shows a post-hole digger handle with the Depth Gauge Indicator (O-Ring) attached.

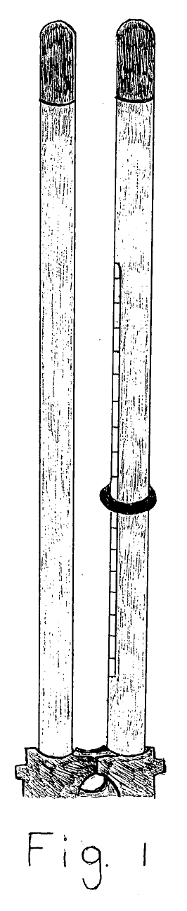

FIG. 2 Shows an exploded view of the handle of the post-hole digger. Included in the view is the Depth Gauge Indicator (O-Ring) and a Gauge with inch markings

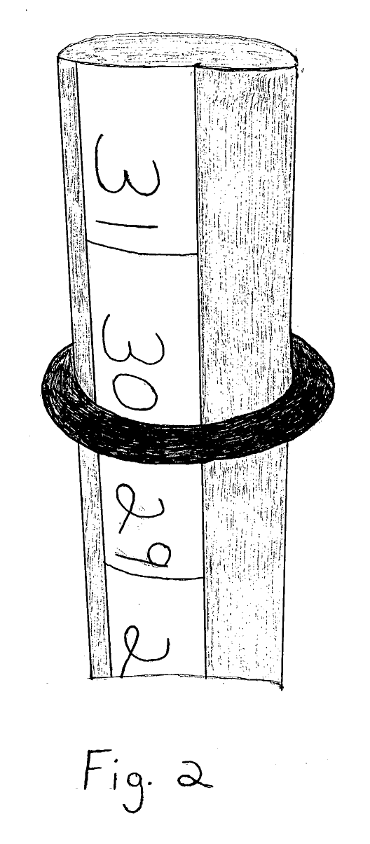

### DETAILED DESCRIPTION OF THE INVENTION

An improved Depth Gauge Reference Indicator for a post-hole digger handle.

An O-Ring is suitable device to use as a Depth Gauge Reference Indicator.

The round shape of the O-Ring allows the O-Ring to be position along the length of the handle. To move the O-Ring the operator rolls the O-Ring with pressure from ones hand to a predetermined position using the attached reference gauge.

The reference gauge is made from a vinyl or plastic type material having an adhesive backing to affix it to the handle of the post-hole digger.

The gauge has inch markings printed on it.

The rubber material that O-Rings is made from provides elasticity for the O-Ring to conform to any shape post hole handle. The O-Ring stays in the predetermined place via friction. The rubber material that O-Rings are made from is suitable for the environment that it will be subject to.

What I claim as my invention is:

1. An attachable gauge that can be affixed to post-hole digger handles.

2. An improved depth gauge reference indicator for handles of a post-hole digger Comprising of an O-Ring.
